(19) United States
(12) Patent Application Publication
(10) Pub. No.: US 2020/0066470 A1
(43) Pub. Date: Feb. 27, 2020

(54) MULTI-FUNCTIONAL MULTI-PURPOSE MAGNETICALLY OPERATED ELECTRIC SWITCH

(71) Applicant: Soweto Abijah Mitchell, Hollywood, FL (US)

(72) Inventor: Soweto Abijah Mitchell, Hollywood, FL (US)

(21) Appl. No.: 16/112,646

(22) Filed: Aug. 25, 2018

(51) Int. Cl. H01H 50/44; H01H 50/54; H01H 47/22; H01H 50/02

(52) U.S. Cl. CPC H01H 50/44; H01H 50/02; H01H 47/22; H01H 50/54

(57) ABSTRACT

A device capable of operating as an electric switch and more particularly as an electric switch wherein the movable contacts of the switch are moved by magnetic fields and also where the switch contacts themselves are connected to the magnets, or are the magnets themselves, using electrically conductive contacts which may either be fastened to, but insulated from the magnets, or are directly attached to the magnets themselves and each contact attached to conductive wire. This switch device was originally designed for fast switching applications and to handle high voltage spikes and small current arcs in order to drive and provide timing for an Energy Efficient motor/fan and POV display where the LEDs for the display are powered solely by, traditionally wasted, high voltage back EMF energy. The scope of this invention, however, covers any motor, fan, engine or other apparatus which is capable of being driven by electrical current flowing through the electric switch device described herein.

### TECHNICAL FIELD

This invention relates to electric switches and necessary improvements in their design and performance capabilities for some applications of these switches, more particularly, to an electric switch which drives a motor or other device capable of doing work, wherein the movable contacts of the switch are moved by magnetic fields and also where the switch contacts themselves are connected to the magnets using electrically conductive materials and wire which may either be fastened to, but insulated from the magnets, or are directly attached to the magnets themselves, in which case the magnets themselves may act as one or more of the electrical contacts.

### BACKGROUND

Switches are ubiquitous components utilized in all disciplines of engineering, especially electrical engineering/electronics and are also present in most of the devices we use everyday. There are a wide range of switches, each with their unique functionality, power consumption (for active switches) and power rating (for both active and passive switches). Common simple switches include latched, flip, lever based, press button types, etc. Most switches have a moving part which connects/disconnects or engages/disengages 2 or more electrical contacts together and are manually triggered. Certain switches are used for fast switching applications like motors and are triggered by an external signal, whether magnetic, electrical, or otherwise.

Motors are an essential driving force and necessary component utilized in all aspects of industry, technology and daily life. There are electrical and non-electrically driven motors with applications including everything from complex robotic systems down to vehicles, pumps and simple household fans. For the purposes of this invention electrically driven motors will primarily be discussed, however, the devices presented in this invention are applicable to all types including even combustion motors. The types of electrical motors range from electrically excited DC motors, permanent magnet based, brushless, switched reluctance, cage and wound rotor induction motors, ironless or coreless rotor motors, etc. Timing of the drive cycle for these motors are controlled typically with a mechanical commutator, a pulse width modulated signal, AC type alternating signal, where the windings become a lot more crucial to overall performance, or in some cases the motor is self timed by a switch which is placed at a particular position along the radial circumference of the rotor's path of travel and which is triggered normally by a small physical member, magnet, or sensor of some kind placed on the rotor itself, triggering the switch every time that particular position of the rotor passes it, or perhaps the switch can be made to fire automatically at set intervals.

Some switches, especially the ones capable of driving motors are solid state devices without any moving parts, for example, Hall effect sensors, transistors and even certain types of relays are utilized as solid state switches for these fast switching applications. One type of switch that is fast switching but contains moving parts is the Reed switch. Hall Effect sensors and transistors use a certain amount of power in order to operate, where as, Reed switches don't, but Reed switches don't have the switching speed capability of Hall effect sensors and/or transistors. All three have limited power rating with transistors being able to withstand much more power consumption than the other two. If one wishes to create a system with as little power dissipation as possible then a Reed switch is best utilized but if high RPMs over a few thousand a required then Reed switches are limited.

There are fundamental problems with utilizing Hall effect sensors as power is lost in the sensor and separately in the transistor, which is normally required for applications over 1 W power consumption. Hall effect sensors use up noticeably more power than Reed switches but as every engineer who has built a motor with Reed switches knows; they have a tendency to burn out and the contacts tend to fuse together if currents exceed a few hundred milliamps due to the tiny size of these contacts. They typically have to be small to allow them to be close enough together to achieve adequate switch sensitivity and switching speed. This happens especially in situations where back EMF or high voltages are harnessed or utilized through the switch even if currents are very small. High voltages, as with back EMF(,) tend to create current arcs over the contacts, which causes them to eventually fuse together.

This invention attempts to remedy some of the issues with these commonly used switches and, in fact, was borne out of frustration stemming from constantly burning out commercially available Reed switches while attempting to design more energy efficient motor systems which drive fans with Persistence Of Vision displays, utilizing bifilar and tri-filar coils, where the POV display is powered by the back EMF generated from the motor's operation, which is harnessed by the primary and secondary coils (tertiary and even more windings are also utilized), and which is normally wasted as EME or blocked by diodes in traditional designs. It became evident that commercially available fast acting switches were not suited for those particular applications and in an attempt to design a magnetically triggered switch which was capable of very high speeds, consumed no current itself but was capable of transferring high voltages and/or currents without burning out quickly, a new multi functional switch was developed capable of being used for many different applications and purposes.

The switch device described herein can be utilized as a magnetic switch or actuator for a wide range of applications including motor switching and/or timing control, security systems, or any device requiring electrical and/or mechanical switching using a magnetic field as the trigger. Mechanical switching is possible with this invention if a freely movable mechanical member is attached to the moving magnet inside the switch which will move each time it interacts with the trigger magnet(s) or if another magnet is placed in close proximity to the moving top or bottom magnet, as shown in FIG. 2, it may be used to trigger something else in a more complex system. Its functionality in the application of an electrical switch for a motor or security system would be similar to that of a Reed Switch but without the need for evacuated glass or small contacts which are unable to switch at very high speeds or carry high currents. This device is able to carry very high currents and because electricity does not need to flow directly through the magnets, no risk of demagnetization due to overcharge or overheat has to occur. This device is able to switch on and off faster than a Reed switch and is only limited by friction of movement on the moving magnet(s) and the speeds of travel allowed by the opposing magnetic fields.

The device may also be used as a press button switch with this present embodiment or even a latched switch in other embodiments with 3 or more magnets. Furthermore, this device serves as a switch/actuator which is able to generate electricity due to its design, especially when used in fast switching applications, e.g. high speed motors as is explained further below and shown in FIG. 5. It also may be utilized as a relay when coupled with secondary magnetically moved contacts.

An advantage of this invention is that it not only functions as a multi-purpose switch but it may also simultaneously function as a fuse where-in metal contacts are utilized with specific melting temperatures, or mercury is utilized which rises away from the contact point when heated, or even more simply where the magnets themselves are thermally and/or electrically connected to the electrical contacts directly and allowed to demagnetize due to either some sufficient rise in temperature or voltage/current. Ensuring contacts don't fuse in such a scenario may be accomplished by having a small spring-like mechanism that locks the movable magnet to the walls of the switch enclosure and which forces it to return to home position when disengaged by the trigger magnet, or by placing a ridge inside the device enclosure (made of non magnetic material) which can be placed in between top and bottom magnets to ensure contacts touch but magnets cannot. Other means of avoiding fused contacts in fault scenarios can be utilized by those skilled in the art.

Another advantage of this switch is its ability to carry higher currents than a traditional reed switch or Hall Effect sensor type of device. Another advantage is that due to the primary moving parts being the magnets themselves, longevity of the switch device is only limited by longevity of the contacts attached to the magnets and also the wires used, but in lower current applications where there is no chance of demagnetization from electrical or thermal overload to the magnets then theoretically this switch could last as long as the magnets do. Another advantage is that, if positioned correctly, the switch, apart from transferring electrical power to trigger coils in a motor application also adds some small amount of mechanical impetus to the rotor. This is achieved when there is the correct interplay of magnetic forces as the rotor magnets pass by the switch pressing down the movable switch magnet, which recoils from the repulsion of the stationary bottom magnet and then possibly adds a slight magnetic kickback to the now passing trigger/rotor magnet or a pull to the proximate one. This interplay seems to reduce current draw slightly for comparable RPMs as compared with a traditional reed switch. Another possible explanation as to this lower current draw is perhaps that by reducing the drag induced by the metal contacts in a Reed switch or even Hall effect sensor slightly lower power is consumed. The average Reed switch has no bleed off or wasted current when the switch is open unlike a Hall Effect Sensor which uses up to 4 mA when open and idle, but the average Reed switch seems to consume more current to attain the same rotor speed as compared to the new magnetically actuated switch discussed herein.

An additional advantage of the design is that it can be encapsulated and so be rendered completely waterproof once sealed. This however is not necessary and open air versions are just as possible but, of course, contacts will corrode in such scenarios.

A final additional benefit of this switch design as compared to existing switches on the market is that small amounts of power can now be harnessed from the switch itself when it is in regular operation, most desirably utilized when high speed switching is involved as in a motor. This may be accomplished utilizing an induction coil wrapped around the switch housing/enclosure and every movement of the magnet when the switch is triggered generates an electric current in the coil which can be fed back into the system or stored in a battery. This current is small but voltage exceeds 5V (at speeds over 1500 rpm in this configuration) and can be used as a trigger sensor voltage signal for speed calculations/speed control, lighting an LED, or a plethora of other applications available to those skilled in the art. Also bigger switches with bigger magnets provide more potential for harnessing more energy from the switch and the higher the switching speed then, of course, the higher the voltage will be. This capability highlights one of the main reasons this switch is an improvement over traditional switches, such as Hall Effect sensors or Reed switches, available on the market today because Reed switches have no powered switch sensing capability, allowing an engineer to measure some voltage change each time the switch is triggered, directly from the switch itself(,) and Hall effect sensors provide some of this ability but require external power to do so. This switching device of my invention captures the best features of both switches but requires no external electrical power source to operate, only the mechanical force of a magnetic/electromagnetic trigger.

The design of this device allows for scalability limited only by the size of the magnets utilized(,) and different versions using as large as 19 mm magnets all the way down to 2 mm magnets were tested successfully. The size of the magnets used in the switch should be matched to the size and power of the activating trigger magnet(s) and distance away from trigger source desired.

The switch device presented here was designed for and tested with an original motor/fan design, which utilizes trifilar coils (each with 3 separate windings) and non-magnetic rotors containing magnets but, for example, no iron core. The design of this motor is focused on using as little power to drive the rotor at as high a(n?) RPM as possible, harnessing the back EMF radiating out from the primary windings which is generated by the magnetic field collapse each time the coil is triggered. The design is also focused on harnessing the magnetic flux energy from each passing magnet through each individual winding. The primary would collect during the part of the duty cycle where power was not applied to the coil. The secondary and tertiary windings would collect the rippling out waves of EMF from the primary and also collecting energy from the magnets like a radial flux generator. In this way enough power is harnessed to light RGB and ultraviolet LEDs which provide the light source for a persistence of vision (POV) system incorporated into the fan application. Some of this HV energy is also fed back into the coils with precise timing and helps with achieving higher rotational speeds. Other applications using the switch device and the motor/generator device which it was used to trigger were tested, but for the purposes of this invention(,) focus will be placed on the very energy efficient POV fan application.

### SUMMARY OF DISCLOSURE

In the original design, the switch device is enclosed in a small tube sealed off with a screw-in plug on top as shown in FIG. 5. In another embodiment 2 screw-in plugs/stoppers were utilized, with one screwed in to the top and the other to the bottom (when tube is viewed vertically). In one embodiment the bottom magnet is fastened to the bottom plug so that its position may be fixed but adjustable. In another embodiment the bottom magnet is freely positioned over a spring which is attached to the screw-in plug and allows for both magnets to move freely but still have the distance between them be adjustable.

The top magnet, as viewed in FIG. 4A-3, is allowed to freely move above the bottom magnet and is suspended above the bottom magnet due to magnetic repulsion between the two magnets. The position of the top screw-in plug may also be adjusted to change the distance of travel allowed for the top magnet. In this way the sensitivity of the switch itself is also adjustable and tweaking of the performance of whatever system it is utilized in may be accomplished on the fly without having to substitute different parts. This capability is one improvement over traditional fast-switching capable switches currently available. In another embodiment (not depicted) 3 magnets are used to provide greater sensitivity or latch switch type behavior depending on the orientation of the magnets. Two magnet configurations will be the present focus.

These two magnets are connected to current carrying wires attached to contacts which are fastened to one face of each separate magnet. The contacts can be attached directly to the magnet or indirectly with a material layer, for example, an insulator placed between them. The contacts are attached on like faces of each magnet, for example, north on one and north on the other. The magnets are moved into and out of engagement with each other or each others contacts, which are attached to each magnet. In the original design wires were attached directly to the contacts which themselves were fastened directly to the magnets and these wires ran through 2 holes in the side of the tube enclosure and then in consequent designs these wires were run through the plugs instead.

In an embodiment with 2 magnets they are made to face each other with opposing magnetic fields, axially magnetized and placed inside a low friction tube at a set distance away from each other, calculated in order to facilitate ready and speedy contact between the two. The magnets and their contact faces could be suspended with opposing fields facing each other and pressed within close proximity of each other by alternate means, e.g. one simple way would be using a low friction rod or screw through the center of 2 magnets which would facilitate one magnet being suspended to float above the other and where both could slide up and down using the rod or screw as an axle/shaft. The magnets utilized for this switch are small and not very strong as it was originally developed for motor applications and less magnetic field strength from the magnets inside the switch provides less interference with the motion of the rotor as its magnets travel within the path of the switch. An additional benefit of smaller, weaker magnets, because their moments of inertia are smaller, is that they are more rapidly moved and require less magnetic force to do so whether applied by a passing magnet of the rotor itself or an electromagnetic coil within the system, etc. Another additional benefit of smaller magnets is it allows for physically smaller switches.

The switch devices created and tested varied in size from 6 mm diameter and 25 mm length tubes up to 19 mm diameter 60 mm length tubes. For the motor application a switch with dimensions 10 mm×35 mm was used. Magnets used were 8 mm×10 mm and 8 mm×2 mm. Electrical contacts tested varied from copper to tin, however in the end 2 soft iron beads were utilized in most switches and standard copper wire was utilized to carry current. Some machine oil may also be placed inside the tube to reduce friction but ridges along the inside wall of the tube are utilized to keep oil within the top half of the tube and/or on the sides of the tube only. Oil is not necessary, however, if the inside surface wall of the enclosure presents low enough friction to facilitate speedy travel of the sliding magnet(s).

In the embodiments discussed here, the switch is utilized within a motor to be used as the primary driver for a fan system. The motor designed contains a plastic rotor core with dimension 50 mm×28 mm and with magnets added to the rotor its diameter extends to about 130 mm. The design of the fan, rotor and blade system as shown in FIGS. 6, 7 and 9 was of dimensions 210 mm×200 mm (d×h). The switch device was placed radially, in close proximity to coils, as shown in FIG. 9 and triggered by each of the 3 passing rotor magnets as seen in FIG. 8. Adjustment and precise positioning of the switch was necessary for optimum performance and was achieved by turning one of the screw plugs just one or two degrees at a time to decrease or increase separation between the switch magnets. This became a very great advantage as different switch sensitivities were required for different fan blades utilized because of weight and drag slowing down or speeding up the timing of the motor.

Electrical energy is applied to the primary windings of the first coil connected to a power source, in this case a 12V and 19V DC power supply, alternated while passing through the second coil and alternated at each of the 4 remaining coils thereafter. This configuration evidently allows for greater RPMs over configurations with coils connected in series, as less current is required to rotate the rotor due to the push/pull action provided by the alternating coils and these alternating coils also create greater electrical field collapses as the coils turn on and off so greater amounts of back EMF may be harnessed as well. Rotor speeds without fan blades reached 2500 RPM consuming 12V/40 mA and reached over 3500 RPM consuming 19V/60 mA while harnessing up to 80V at 8-10ma in back EMF with smaller Voltage spikes over 200V which when rectified and buffered was more than enough to power over 20 LEDs for a persistence of vision display.

The persistence of vision display was achieved by mounting LED strips along the inner surface wall of the fan enclosure and they were hidden from direct view by device user. The light from these LEDs reflect off the mirrored blades of the fan and then bounce off the mirrored wall of the inner enclosure and create a circular POV display to anyone viewing the blades. In this way no LEDs are physically present or can be seen on the fan blades when the fan is not in operation. This allows for a sleeker, less cluttered and more elegant design. This innovation also allows for a lighter fan blade while still creating a bright POV display. This also allows for more LEDs to be utilized in the display as there is more surface area radially along the circumference of the enclosure than on the blade itself and wires and circuitry can be left off the blades/axle/rotor sections. This is a noticeable improvement over traditional POV fan displays currently available due, in part, to a less cluttered, lighter blade which consumes less current to achieve comparable RPMs.

In summary, a very energy efficient, durable, extremely versatile and new magnetic switch device was created to more reliably drive and provide timing for a motor where high voltage back EMF was to be harnessed and utilized. This very energy efficient motor system was designed using bifilar coils, trifilar coils and, in one embodiment, coils with more than 3 windings. The motor system was used to power a very energy efficient fan system with POV display where LEDs are partially or fully powered solely using back EMF and the power collected from the radial flux energy generated by the rotation of the magnetic rotor and collected in the primary, secondary and tertiary windings of the electromagnetic coils, shown in FIG. 9 (individual windings not shown). In a later embodiment a cooling system utilizing Peltier Cooling modules was also designed but illustrations are not provided here since that is not in the scope of the claims. The design then evolved to be a very portable, multifunctional and efficient POV fan and cooling system driven by the trifilar coiled motor which was made possible by the unique design of the Multi-Functional Magnetic Switch Device which provided power to and timing for the motor.

### BRIEF DESCRIPTION OF DRAWINGS

FIG. 1 shows a vertical side view, top-side view and bottom-side view of the Multi-Functional Magnetic Switch Device.

FIG. 2 shows an internal vertical side view, top-side view and bottom-side view of the Multifunctional Switch Device. This also shows magnets and contacts within the tube enclosure.

FIG. 3 shows an internal view of magnets close enough for contacts to touch.

FIG. 4 shows an internal view of switch device with an attempt to illustrate different materials utilized such as 2 different types of magnets or a magnet and a small copper cylinder where the cylinder is stationary and the magnet is moved by the trigger and returned to home position with a spring as a cheaper construction method. Also attempts to show the switch with the pickup coil are included in figures B, C, and D.

FIG. 5 shows the magnetic switch device with screw plug which is used for sealing of the device and adjustment of switch sensitivity, a view of the device with top and bottom wires and also a view of the device with side mounted electrical wires and a press button on the top.

FIG. 6 shows the top, top-side and side profile view of the motor/fan apparatus for which the switch device was originally developed.

FIG. 7 shows the bottom and bottom-side view of the motor/fan apparatus.

FIG. 8 shows multiple views of the motor's rotor with and without magnets.

FIG. 9 shows the entire system with the motor and switch device integrated into the POV Display Mirror Fan application.

### DETAILED DESCRIPTION OF DRAWINGS

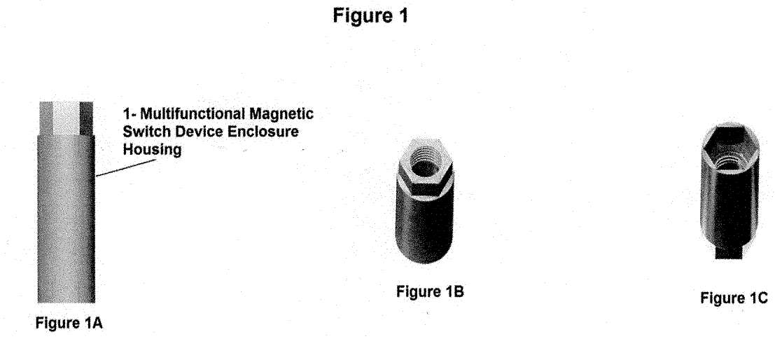

In FIG. 1 depicted are 3 views (“A” is profile side view, “B” is the top-side view, “C” is the bottom-side view) of one embodiment of the Multifunctional Magnetic Switch Device, without screw-in plugs, where “1—Multifunctional Magnetic Switch Device Enclosure Housing” denotes the outer shell of the device within which is placed 2 or more magnets with electrical contacts and wires fastened to them. Other embodiments of the design included a rectangular tube, however, the circular design was more adjustable and could be manufactured somewhat smaller due to the round cylindrical internal area for the cylindrical or circular magnets. A tube that is rectangular in shape would be necessary for rectangular shaped magnets and other shapes maybe envisioned by those skilled in the art.

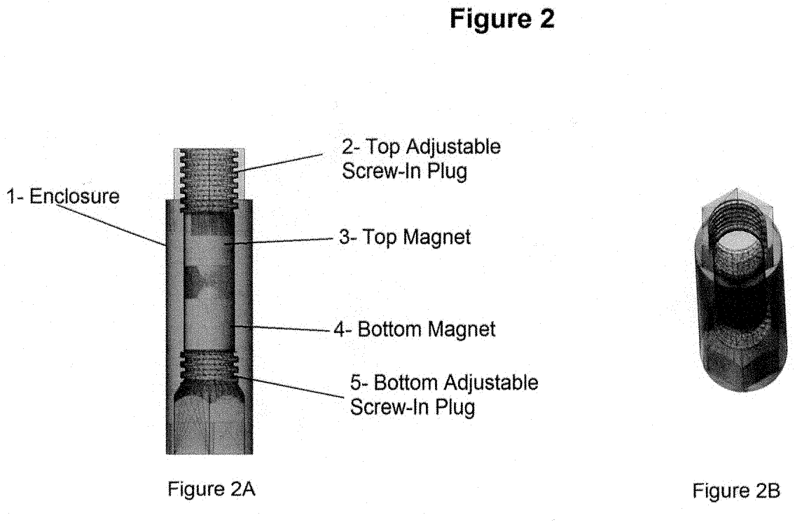

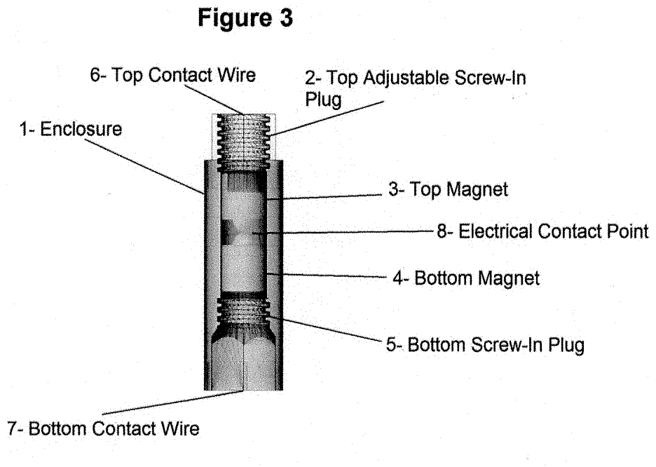

In FIG. 2 there are depicted 2 internal views (“A” and “B”) of the switch device where “1—Enclosure” denotes the enclosure housing for the magnets and contacts. “2-Adjustable Screw-In Plug” and “5—Bottom Adjustable Screw-In Plug” denotes the top plug and bottom plugs, respectively, which are adjustable by turning the screw a few degrees at a time to increase or decrease separation between the contacts. “3—Top Magnet” and “4—Bottom Magnet” illustrate the resting position of the top and bottom magnets which are connected to the top and bottom contacts by the top and bottom wires shown in FIG. 3. The physical location/orientation denoted as Top or Bottom is relative and could easily be denoted as Left Magnet and Right Magnet or magnet 1 and magnet 2 when the tube is rotated 90 degrees.

In FIG. 3 an internal view of the Switch device is presented which shows “6-Top Magnet Wire” and “7—Bottom Magnet Wire”. “1—Enclosure”, “2—Adjustable Screw-In Plug”, “5—Bottom Adjustable Screw-In Plug”, “3—Top Magnet” and “4—Bottom Magnet are also depicted but the only difference between this illustration and FIG. 2 is the Switch Input/Output electrical leads denoted as Top and Bottom Magnet Wires.

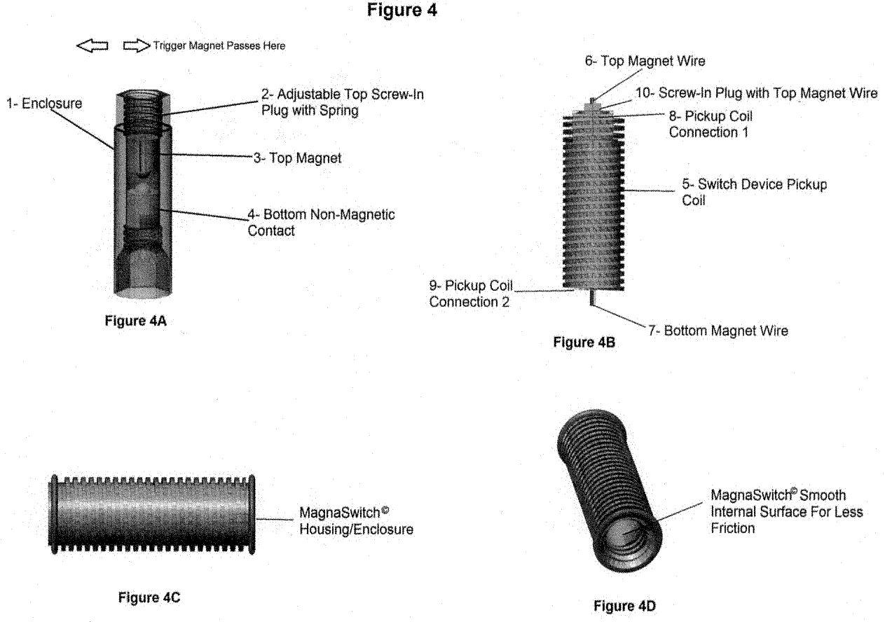

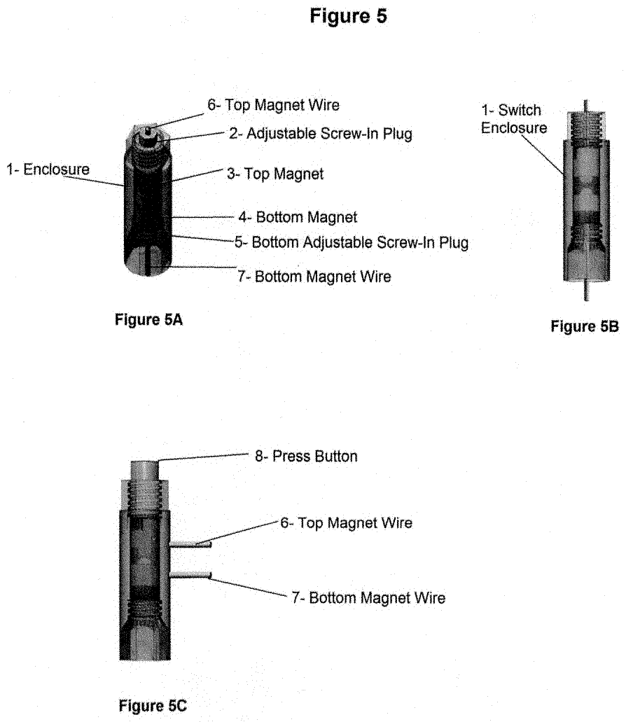

In FIG. 4A there is an attempt to illustrate different materials which may be utilized, for example, 2 different types of magnets or a magnet and a small copper cylinder, denoted by “3—Top Magnet” and “4—Bottom Non-Magnetic Contact” where the cylinder is stationary and the magnet is moved by the trigger and returned to home position with a spring as a cheaper construction method. Instead of using two cylindrical objects which connect together to complete the electrical connection (i.e. Top Magnet and Bottom Magnet), whether 1 is magnetic and 1 non-magnetic, or both are magnetic, only 1 magnet and a wire would also work nearly as well. The Top Magnet, for example, could be made through repulsion of the Trigger Magnet to make contact with a wire or small flat electrically conductive contact of some kind mounted through the side of the tube or anywhere else on the enclosure as shown in FIG. 5C. This secondary contact may even be wireless if that terminal is terminated into a coil with turns matched to the power transmitter/receiver coil connected to the power source. Consequently, different configurations using only 1 or possibly more than 3 magnets may be envisioned by those skilled in the art.

FIG. 4B attempts to show the switch device with Top and Bottom Magnet Wire depicted by “6—Top Magnet Wire” and “7—Bottom Magnet Wire”, respectively, and with the pickup coil shown as “5—Switch Device Pickup Coil” with its input and output connections denoted by “8—Pickup Coil Connection 1” and “9—Pickup Coil Connection 2”. One of these connections may also be connected to the Top or Bottom Magnet wire and, in this manner, transform the pickup coil into one end of a wireless power link whereby placing a matched coil in close proximity would allow for a somewhat wireless switch. A completely different coil may also be utilized instead for a wireless power connection terminal. FIG. 4A also attempts to illustrate which direction the trigger magnet travels in, which would typically be on a path perpendicular to the housing of the switch itself. The switch is very flexible and can be triggered from the top, bottom or side butwith varying sensitivities and reliability. FIGS. 4C and 4D show alternate views of one intended design for the switch device and the product name.

FIG. 5 shows three internal views (A, B, and C) of the switch device where the Adjustable Screw-In Plug is shown from the top-side perspective and all other items are highlighted in previous Figures. In FIG. 5C, however, an illustration of a Push Button variation of the switch device is presented wherein the top screw-in plug, “2—Adjustable Screw-In Plug”, is replaced by a button (or non magnetic cylinder), depicted as “8—Press button”, which is free to move in and out of the internal cylindrical cavity of the switch and is connected physically and/or electrically, but not necessarily fastened to the top magnet. This can be achieved with a spring between the button and magnet, for example. When the button is pressed the top magnet is also depressed and forced to make contact with the bottom magnet then, of course, is repelled back with the magnetic repulsion between the two magnets.

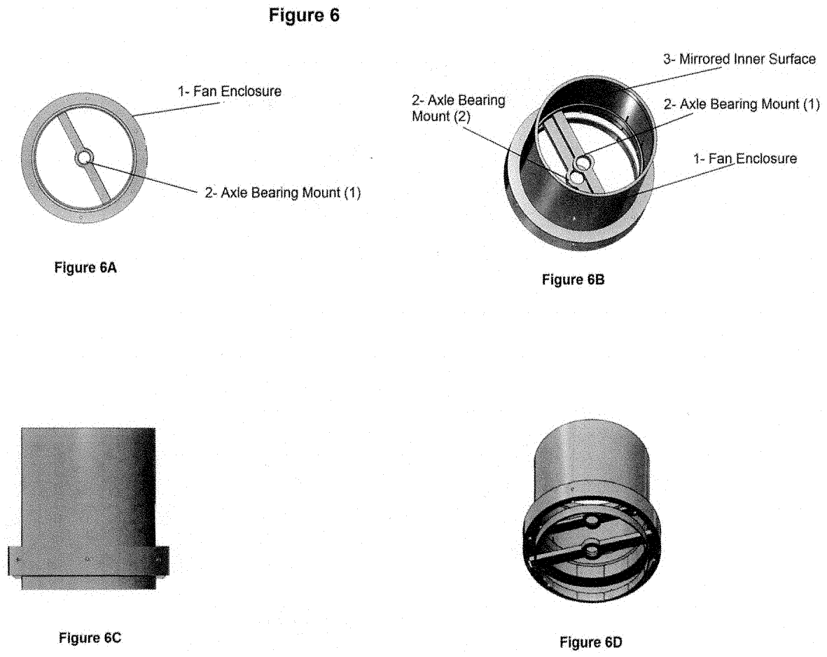

In FIG. 6 there are depicted four views of the fan system's enclosure housing (A, B, C and D), which the magnetic multifunctional motor switch device of this invention was originally designed for. In FIG. 6A a top view is presented. In FIG. 6B “1—Fan Enclosure”, “2—Axle Bearing Mount 1” and “2”, and “3—Mirrored Inner Surface” of the enclosure are shown. FIG. 6C shows a side view and 6D shows a bottom-side view of the Fan enclosure without any rotor, coils, switch device or fan blade included.

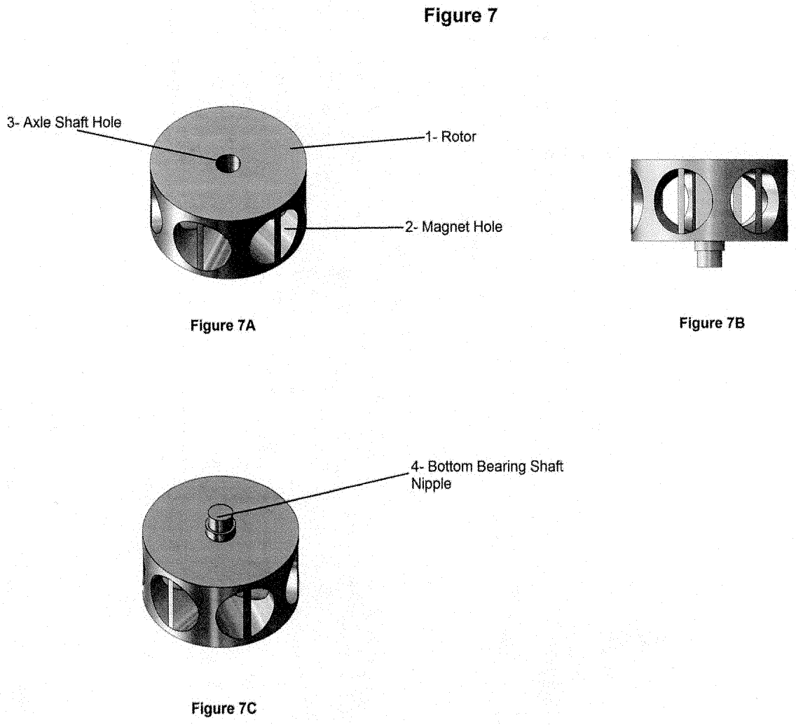

FIG. 7 shows one embodiment of one of the rotors used in the fan system providing 3 views, top-side view A, side view B and bottom-side view C. In this embodiment the rotor was designed with 6 “2—Magnet Holes” to contain 6 magnets each separated by 60 degrees. Tests were conducted using 3 and 6 magnets and the results of 2500 RPM consuming 12V/40 mA without a fan propeller were achieved using 6 magnets that were each 32 mm Diameter and 10 mm thick. The “3—Axle Shaft Hole” shows where the fan shaft is mounted and the shaft/axle is removable to facilitate easy blade changes. The “4—Bottom Bearing Shaft Nipple” contains diameter 8 mm and length 4 mm with a ridge around it like a bearing spacer which allows it to be mounted and removed from/to the “2—Axle Bearing Mount 2” shown in FIG. 6. The length of 4 mm allows it to be mounted into but not extend through the body of the bearing which was utilized or its mount.

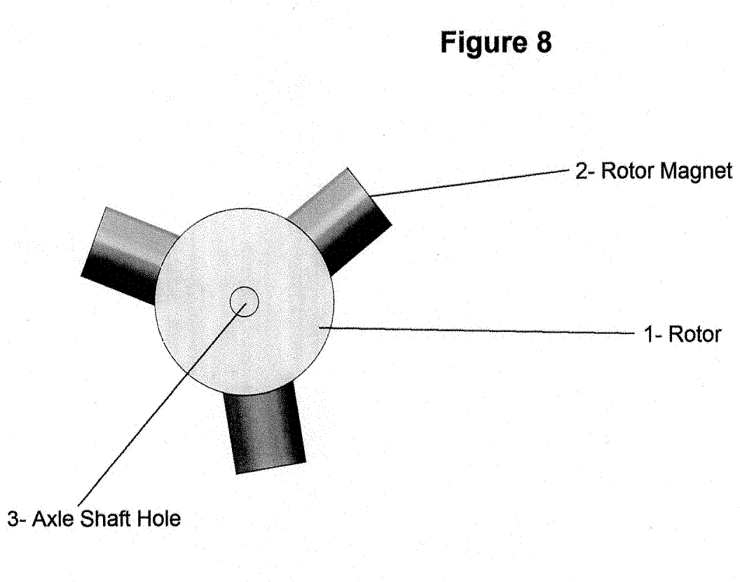

In FIG. 8 depicted is one embodiment of the fan rotor with 3 magnets, instead of 6, denoted by “1—Rotor” which is the body of the rotor itself, “2—Rotor Magnet” which were 20 mm in diameter and 45 mm in length for this embodiment and a top view of the “3-Axle Shaft Hole”

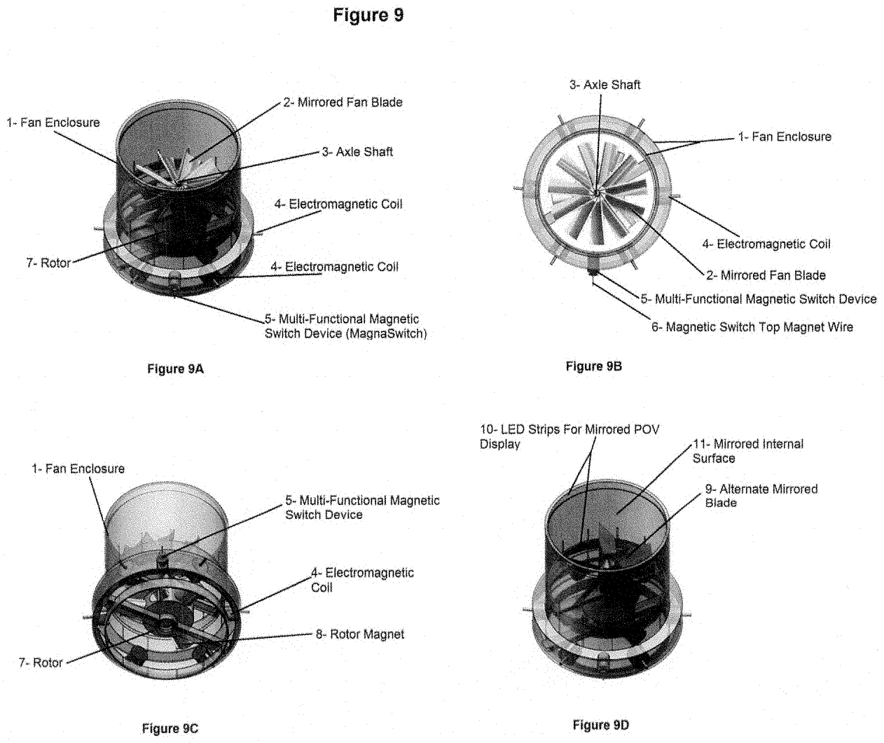

In FIG. 9 there are depicted four views of the complete fan system including the Multifunctional Magnetic Switch Device shown as a top-side view A, a top-view B, a bottom-side view C and an alternate top-side view D. In FIG. 9A “1-Fan Enclosure” denotes the outer housing shell of the fan system, designed like an induction vent fan to make the design portable. In the event the LED POV system or mirrored blades are needed then the design allows it to be plugged in standard induction venting AC systems. The design is meant to be mountable to a flexible rotating stand like a traditional table fan but also mountable to the ceiling with additional brackets. The round design was also necessary for this particular POV design developed with this fan system where the LEDs would not be mounted to the fan blades themselves but instead have their light mirrored off of the mirror blades (“3—Mirrored Fan Blades”) and circular mirrored interior face of the enclosure. This creates not only a POV display reflected on the fan blades instead of emanating from them, but also a holographic effect due to the focal point distance of the circular mirrored design. In this way the design makes the fan system multifunctional and not only the original switch which drives it. FIG. 9A also shows the position of the “7—Rotor”, “4—Electromagnetic Coils” and the “5—Multi-Functional Magnetic Switch Device”.

FIG. 9B shows a top view where “3—Axle Shaft” can clearly be seen which serves as the axle that is mounted into the Axle Shaft Hole depicted in FIG. 8 and upon which the “3—Mirrored Fan Blade” is mounted. FIG. 9C shows a bottom-side view in which the “4—Electromagnetic Coils” can be seen more clearly. In FIG. 9D a view is presented of a “9—Alternate Mirrored Blade” which shows a somewhat sleeker Fan blade design which provides different performance characteristics to the first fan blade shown in FIG. 9A. The positions of the LED strips are also shown where standard RGB and also UV LEDs were utilized in various alterations to this embodiments of the design. An attempt is also made to show the mirrored surface which forms the interior wall of the fan enclosure (“11—Mirrored Internal Surface”).

1. A device capable of operating as an electric switch and more particularly as an electric switch wherein the movable contacts of the switch are moved by magnetic fields and also where the switch contacts themselves are connected to one or more magnets, or are the magnet(s) themselves, utilizing electrically conductive contacts which may either be fastened to, but insulated from the magnets, or are directly attached to the magnets themselves, or are placed in close enough proximity to be pushed or pulled to physically interact with the contact(s) when a Trigger Magnet traverses past or near the device and each electrical contact then attached to conductive wire or electromagnetic coil if wireless electrical connection is desired.

2. An electric switch device with electrical contacts fastened to magnets or which are magnets themselves, that may be utilized in more than one application or function including but not limited to fast switching applications, including acting as an electromagnetic trigger like a Reed switch, a press button/plunger or toggle switch, limit switch, electromagnetic sensor, as a fuse, even as a power generation device, simultaneously without changing the design or altering any of the components after manufacture and also where distance between contacts may be adjusted to easily control or affect sensitivity of the switch which may affect performance factors, including, but not limited to switching speed and electrical current allowed to flow through the switch.

3. An electric switch device, as described in claim 1, capable of fast switching and requiring no electrical power input to operate, but capable of switching speeds greater than a Reed switch.

4. An electric switch that is triggered by a magnetic/electromagnetic force and which harnesses electromagnetic energy from the passing trigger magnet/electromagnet and also from the movement of the magnet(s) within the switch itself, captured in a pickup coil or set of coils positioned around the switch enclosure, capturing energy which may then be stored or otherwise utilized in the system and where said pickup coil may also be utilized as the receiver of a wireless electrical connection if an electromagnetically matched coil is placed in close enough proximity to the switch device and serves as the wireless power inducer/transmitter.

5. An electric switch, as described in claim 4, capable of fast switching and providing measurable voltages each time the switch is triggered for use in, but not limited to, for example, detecting every time the switch is triggered for speed measurement, or powering LEDs, but which requires no electrical input power to operate.

6. An electric switch device as described in claim 1 which is capable of fast switching but able to withstand currents exceeding the limits of presently available reed switches or Hall effect sensors, where current carrying potential is only limited by the wires and contacts, especially when switch magnets are thermally and electrically insulated from the contacts themselves.

7. An electric switch device, as described in claim 2, where contacts can be engineered to not fuse together as they do in a Reed switch, potentially creating a fire hazard in high power motor applications, by utilizing low temperature melting point metals or attaching electrical contacts directly to magnets in order to render them demagnetized if heat or electrical energy exceed a certain amount.

8. An electric switch device as described in claim 4 where back EMF may be harnessed directly through the switch without fusing the contacts together due to arcing, as typically occurs in a Reed switch or overloading and short circuiting the device as occurs with a Hall effect sensor.

9. A switch device, as described in claim 2, which can be utilized as a magnetic contact-less actuator as well as an electrical switch for a wide range of applications including motor switching and/or timing control, security systems sensing, or any device or application requiring electrical and/or mechanical switching using a magnetic field as the trigger where one moving magnet inside the switch enclosure is arranged to influence the movement of another magnet inside or outside of the same enclosure or tube forming somewhat of a mechanical relay whose interacting members may be attached to current carrying wire and rendered an electrical relay with a magnetic trigger.

10. A device as described in claim 2 in which mechanical switching is possible if a freely movable mechanical member is attached to the moving magnet inside the switch which will move each time it interacts with the trigger magnet(s) or if another magnet is placed in close proximity to the moving top magnet, preferably, outside the switch tube/enclosure and which may be used to trigger something else in a more complex system.

11. A switch device, as described in claim 4, which can perform as a multi function, high-speed capable switch, but which can also be made to function as an electromagnetic actuator by applying a voltage to the coil wrapped around the device's enclosure.

12. A switch device as described in claim 2, where contacts don't fuse together in a fault situation and where contacts separate from each other as in a fuse, accomplished by having a small spring-like mechanism that locks the movable magnet to the walls of the switch enclosure and which forces it to return to home position when disengaged by the trigger magnet or by placing a ridge inside its enclosure which can be placed in between magnets to ensure contacts touch but magnets don't, a scenario which is especially likely in embodiments where meltable contacts are used.

13. An electric switch device, as described in claim 1, which is capable of extremely long life, where the only moving parts are magnets which never touch so longevity is only limited by the life of the contacts, wires and physical integrity of the enclosure.

14. A switch device as described in claim 2 which, if positioned correctly, the switch, apart from transferring electrical power to trigger coils in a motor application also adds some small amount of mechanical impetus to the rotor; achieved when there is the correct interplay of magnetic forces as the rotor magnets pass by the switch pressing down the movable switch magnet, which recoils from the repulsion of the stationary bottom magnet and then adds a slight magnetic kickback to the now passing trigger/rotor magnet and/or attraction to the next approaching magnet in a rotating rotor with a plurality of magnets.

15. An electric switch device as described in claim 1 which due to being encapsulated can also be rendered completely waterproof once sealed but is low cost to manufacture, long lasting and requires no external electrical power.

16. A motor, fan, engine or other apparatus where the device described in claim 1 or any switching device derived from it is utilized in any capacity.

17. A motor, fan, engine or other apparatus which is driven by electrical current flowing through the electric switch device described in claim 2 or any switching device derived from it.

18. A motor, fan, engine or other apparatus which is driven by electrical current flowing through the electric switch described in claim 4 or any switching device derived from it.

19. A motor, engine, fan, generator or other device which utilizes electromagnetic coils with more than 2 separate windings for, but not limited to, the collection of electromagnetic flux energy from passing magnets and/or high voltage back EMF energy from a system where fast switching of the primary or any particular winding is employed.

20. A motor, fan, engine or other apparatus which utilizes electromagnetic coils with any number of windings and the switch device as described in claim 1.

21. An electric switch device, as described in claim 2, where distance between contacts may be adjusted to controllably and easily affect sensitivity of the switch which may affect performance factors, including, but not limited to, speed of rotation and electrical current allowed to flow through the switch.

22. A Persistence of Vision (POV) Display, especially a rotating POV display where LEDs are positioned radially along the path of trajectory or circumference around the path of trajectory of a mirrored moving or rotating mechanical member or fan blade which reflects the light from the LEDs and in so doing, remove the necessity for mounting the LEDs on the rotating member or fan blade itself.

23. A motor, engine, fan, generator or other device as described in claim 19 where voltage gains are achieved by utilizing a fast switching device to switch the generator pickup coils on and off in order to reduce drag, for example from Lenz effects, and also harness the high voltage back EMF which results from the collapsing field each time some or all of the coils are switched off.
